(19) United States
(12) Patent Application Publication
(10) Pub. No.: US 2006/0200490 A1
(43) Pub. Date: Sep. 7, 2006

(54) Geographical indexing system and method

(76) Inventor: Roger Owen Abbiss, Dundas (CA)

Correspondence Address: BERESKIN AND PARR, 40 KING STREET WEST, BOX 401, TORONTO, ON, M5H 3Y2, CA

(21) Appl. No.: 11/366,489

(22) Filed: Mar. 3, 2006

Related U.S. Application Data
(60) Provisional application No. 60/657,926, filed on Mar. 3, 2005.

(51) Int. Cl. G06F 7/00

(52) U.S. Cl. 707/102

(57) ABSTRACT

A geographical indexing system and method for use in association with a plurality of search results and a user-selected location. A user-selected location is obtained by providing a user with a graphical geographical map and receiving a user-selected location on the graphical geographical map. Geographically indexed search results are obtained by indexing a plurality of search results by geographical proximity to the user-selected location, and displaying those results to the user. A set of targeted search results are then determined from the indexed search results and a user request for information is obtained. The user request for information is then sent to a set of targeted search result contacts associated with the targeted search results and the responses are received and aggregated and then displayed, stored or forwarded to the user.

### CROSS-REFERENCE TO RELATED APPLICATIONS

This application claims the benefit under 35 U.S.C. 119(e) of U.S. Provisional Patent Application No. 60/657,926, filed Mar. 3, 2005, the contents of which are incorporated by reference herein.

### FIELD

The embodiments described herein relate to indexing systems and methods and in particular to a geographical indexing system and method.

### BACKGROUND

A search engine is a tool application used to search a database of information against given criteria, and to return database entries that match or contain those criteria. In particular, Internet search engines search an indexed database of web pages, either submitted to the search engine or discovered using crawlers. A crawler, or indexing robot, is an application used by the search engine to branch out across the Internet to collect web pages. When the crawler reaches a web page, it follows each of the links on that web page. The crawler repeats this recursive process upon reaching each new web page. The web pages it discovers are each indexed and entered into the search engine's database. When a search is entered into the search engine, the query is run against the indexed database, and a list of search results is returned.

The Internet contains billions of web pages, and is growing exponentially. Hundreds or thousands of web pages are added to the Internet each day. As a result, a comprehensive search engine database contains billions of web pages. Moreover, for any given query against the database, extremely large numbers of results may be returned. For example, searching for the string ‘cat’ using the search engine Google™ yields 141 million web pages, representing a wide variety of information, including felines, CAT scans and Caterpillar™ industrial equipment.

Due to the overwhelming number of results for a query, not all search results will be relevant to the interests of a particular user, and a user will generally not read the complete list of search results. Accordingly, the search engine attempts to present the most relevant search results first. To do this, search engines rank results based on certain criteria for determining the probability that a given result is relevant to the user. These criteria may include the age of the given result, the number of users who entered the same query and chose the given result from the list of search results, or the number of other web sites that refer to the given result.

Another criterion by which search results can be ranked is geographical location. Ranking search results by geographical location is known as localized searching. A localized search allows the user to find results near a given geographical location (e.g. plumbers in Toronto). The geographical location may be selected by the search engine (e.g. the centre of Toronto or the location of town hall) or entered by the user (e.g. the user's home location). The goal of a localized search engine is to provide geographically relevant results with optimal user friendliness.

Major participants in the field of internet search are devoting resources to this end. Industry leaders convene at conferences around the world, such as the Kelsey Group Conference, to discuss advances in localized searching, but problems of geographical relevance of results and user friendliness of interface remain to be solved. To date, search engines are reasonably successful at determining geographical relevance, but are not optimally user friendly. A modern search engine may require a user to enter a search string containing key words that are parsed according to rules in the search engine parser (e.g. ‘Plumber near 1 Yonge Street Toronto’, where ‘near’ is a key word with special meaning to the search engine). This method allows the user freedom to enter any search string, but for reasonable success the user must be aware of the keywords of the parser. A search engine may instead require the user to enter a search term and a location in separate designated fields (e.g. ‘Plumber’ in a subject field and ‘Toronto’ or ‘L6H 3J6’ in a location field). This method allows the search engine to verify the location entered against a list of known locations. However, it is also restrictive to the user (e.g. ‘The Big Apple’ may not be listed as a known location) and, depending on the number of separate fields, can be tedious and time consuming to use.

If geographically relevant search results are determined and presented to the user, the user may wish to communicate with the organizations, businesses or other entities described by the search results, especially where the search results represent goods or services. For example, if the user wishes to purchase firewood from a local supplier, and searches for the term ‘firewood’ in a localized search engine, the user will receive a list of search results containing firewood suppliers located near their selected location. These search results may include contact information for each business represented in the results. If the user wishes to determine the provider of the cheapest or driest firewood, the user must contact each business individually. The user must also manage the large number of responses they receive (e.g. ideally one response per business contact). This is a tedious but currently common process for a user to undertake.

None of these existing solutions provide an optimally user friendly method of gathering location information from the user, which is critical to guarantee relevant local results, or a mechanism for the user to communicate directly and effectively with a group of organizations, businesses or other entities represented in the search results.

### SUMMARY

The embodiments described herein provide in one aspect, a geographical indexing system for use in association with a plurality of search results, said geographical indexing system comprising:
(a) a memory for storing a user-selected location;
(b) a processor coupled to the memory for:
   (i) obtaining the user-selected location by:
      (I) providing a user with a graphical geographical map;
      (II) receiving the user-selected location as selected by the user on the graphical geographical map; and
   (ii) indexing the plurality of search results based on the user-selected location.

The embodiments described herein provide in another aspect, a method for geographically indexing a plurality of search results, said method comprising:
(a) obtaining a user-selected location by:
   (i) providing a user with a graphical geographical map;
   (ii) receiving the user-selected location as selected by the user on the graphical geographical map; and
(b) indexing the plurality of search results based on the user-selected location.

The embodiments described herein provide in another aspect, a request for information system for use in association with a plurality of search results, said indexing system comprising:
(a) a memory for storing a user request for information;
(b) a processor coupled to the memory for:
   (i) determining at least one targeted search result contact from the plurality of search results;
   (ii) receiving the user request for information;
   (iii) sending the user request for information to the at least one targeted search result contact; and
   (iv) receiving at least one response from the at least one targeted search result contact.

The embodiments described herein provide in another aspect, a method for use in association with a plurality of search results, said method comprising:

(a) determining at least one targeted search result contact from the plurality of search results;

(b) receiving the user request for information;

(c) sending the user request for information to the at least one targeted search result contact; and

(d) receiving at least one response from the at least one targeted search result contact.

Further aspects and advantages of the embodiments described herein will appear from the following description taken together with the accompanying drawings.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of an exemplary embodiment of a geographical indexing system;

FIG. 2 is a flowchart illustrating the basic operational steps of the geographical indexing system of FIG. 1;

FIG. 3A is a schematic diagram illustrating how the user-selected map point is determined;

FIG. 3B is a schematic diagram illustrating how the search results are ranked by geographical location;

FIG. 3C is a schematic diagram illustrating how the search results are displayed after the user has selected to send an e-mail user request for information (RFI) to all or selected listings;

FIG. 3D is a schematic diagram illustrating how a direct or e-mail user RFI is configured;

FIG. 3E is a schematic diagram illustrating how a direct or e-mail user RFI is composed without using an existing template;

FIG. 3F is a schematic diagram illustrating how a direct or e-mail user RFI is composed using a template;

FIG. 3G is a schematic diagram illustrating how an aggregated information response is prepared;

FIGS. 4A and 4B are flowcharts illustrating the operation of the indexing module of FIG. 1;

FIG. 5 is a flowchart illustrating the operation of the searching module of FIG. 1;

FIG. 6 is a flowchart illustrating the operation of the location module of FIG. 1;

FIG. 7 is a flowchart illustrating the operation of the ranking module of FIG. 1;

FIG. 8 is a flowchart illustrating the operation of the collection module of FIG. 1;

FIG. 9 is a flowchart illustrating the operation of the listing module of FIG. 1;

FIG. 10 is a flowchart illustrating the operation of the geographical indexing system of FIG. 1 in response to receipt of a search request by e-mail;

FIG. 11 is a flowchart illustrating the operation of geographical indexing system of FIG. 1 in response to receipt of a request to send a user RFI by voice mail;

FIG. 12 is a flowchart illustrating the operation of geographical indexing system of FIG. 1 in response to receipt of a request for driving directions;

FIG. 13A is a schematic diagram illustrating a search entry from a mobile device within geographical indexing system of FIG. 1;

FIG. 13B is a schematic diagram illustrating search results on a mobile device within geographical indexing system of FIG. 1;

FIG. 13C is a schematic diagram illustrating how the user-selected map point is determined on a mobile device by input string within geographical indexing system of FIG. 1;

FIG. 13D is a schematic diagram illustrating how the user-selected map point is determined on a mobile device by graphical geographical map within geographical indexing system of FIG. 1;

FIG. 13E is a schematic diagram illustrating search results ranked by geography on a mobile device within geographical indexing system of FIG. 1;

FIG. 13F is a schematic diagram illustrating how a search result location is displayed on a graphical geographical map on a mobile device within geographical indexing system of FIG. 1;

FIG. 14A is a schematic diagram illustrating how a detailed view for a search result is presented to the user within geographical indexing system of FIG. 1;

FIG. 14B is a schematic diagram illustrating how a start location for driving directions is determined using a graphical geographical map within geographical indexing system of FIG. 1;

FIG. 14C is a schematic diagram illustrating how driving directions are presented to the user within geographical indexing system of FIG. 1;

FIG. 15A is a schematic diagram illustrating how a search zone is defined by selecting points on a graphical geographical map within geographical indexing system of FIG. 1;

FIG. 15B is a schematic diagram illustrating how a search zone is named within geographical indexing system of FIG. 1;

FIG. 15C is a schematic diagram illustrating how multiple search zones are displayed and searched within geographical indexing system of FIG. 1;

FIG. 15D is a schematic diagram illustrating how search results are displayed after a zone search within geographical indexing system of FIG. 1;

FIG. 16A is a schematic diagram illustrating how geographical user preferences are configured; and

FIG. 16B is a schematic diagram illustrating how topical user preferences are configured.

It will be appreciated that for simplicity and clarity of illustration, elements shown in the figures have not necessary been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The invention may be implemented in hardware or software, or a combination of both. However, preferably, the invention is implemented in computer programs executing on programmable computers each comprising at least one processor, a data storage system (including volatile and non-volatile memory and/or storage elements), at least one input device, and at least one output device. Program code is applied to input data to perform the functions described herein and generate output information. The output information is applied to one or more output devices, in known fashion.

Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage media or device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

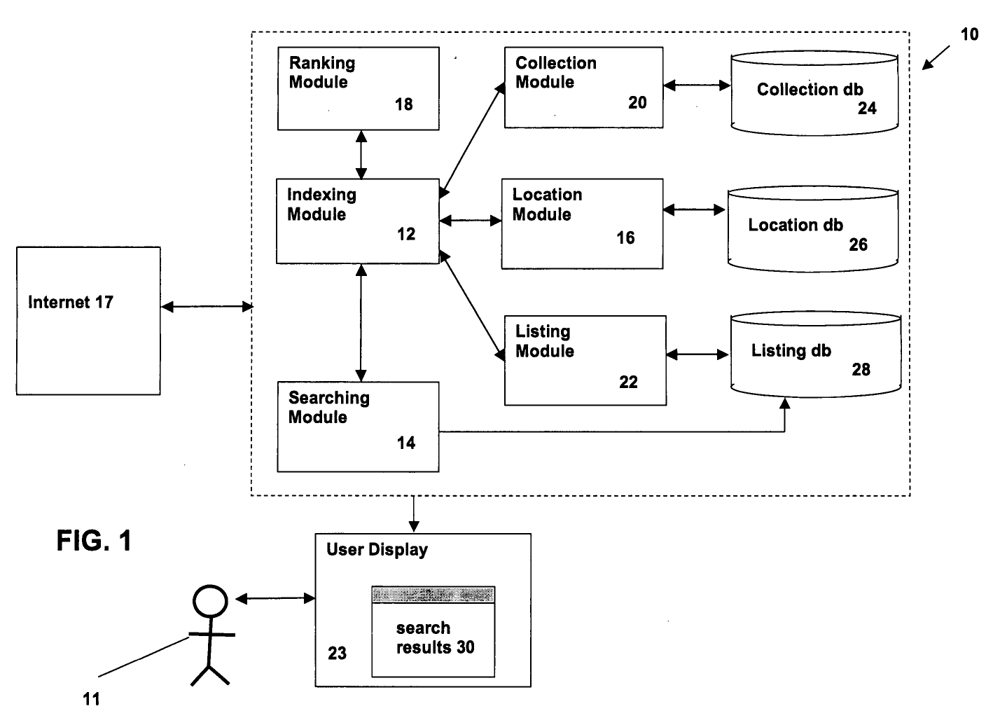

FIG. 1 is a block diagram of an exemplary embodiment of a geographical indexing system 10. Geographical indexing system 10 includes an indexing module 12, a searching module 14, a location module 16, a ranking module 18, a collection module 20, a listing module 22, a collection database 24, a location database 26, and a listing database 28. As will be described in detail, geographical indexing system 10 utilizes a user-selected map point to rank Internet or database search results by geographic proximity to the user 11. Once the search results are presented to the user 11 on user display 23, geographical indexing system 10 provides the user 11 with the ability to configure a user request for information (RFI) to be sent to search result contacts of interest. Geographical indexing system 10 then collects and aggregates responses from search result contacts of interest on administrative display 21 and forwards them to the user 11 in a user-friendly format.

The indexing module 12 coordinates all of the operations of the searching module 14, the location module 16, the ranking module 18, the collection module 20 and the listing module 22. Indexing module 12 utilizes listing module 22 to gather and index listings in the geographical indexing system and searching module 14 to determine search results 30 to be presented to the user 11 on user display 23. Indexing module 12 also utilizes location module 16 to gather a user-selected map point, and ranking module 18 to sort listing database 28 search results 30 based on geographic proximity to the user-selected map point gathered by location module 16. Indexing module 12 utilizes collection module 20 to configure a user RFI to be sent to search result contacts of interest.

The searching module 14 performs what is conventionally known as database searching. Searching module 14 searches listing database 26 based on a search string gathered by location module 16 or stored in location database 26. Search results 30 are returned to indexing module 12 for display on user display 23.

The location module 16 gathers geographical information in the form of a user-selected map point (i.e. user's home location, user's work location, or alternative user location) from user 11 by presenting the user with a graphical geographical map. Location module 16 returns the user-selected map point to indexing module 12.

The ranking module 18 is used to geographically rank the search results 30 generated by searching module 14 according to location particulars determined by the location module 16. Ranking module 18 returns the indexed search results 30 to indexing module 12 for display to user 11 on user display 23.

058 The collection module 20 is used to determine a user RFI, store the user RFI in the collection database 24 and then forward it through the indexing module 12 for dissemination to target search result contacts of interest. Collection module 20 also gathers and manages responses from target search result contacts of interest to the user 11, and stores them in collection database 20.

The listing module 22 manages information regarding listings. Listing module 22 retrieves information regarding listings (e.g. physical address, e-mail address) from listing database 28.

The collection database 24 contains information relating to existing user RFIs that have been sent by the user 11 to targeted search result contacts of interest, as well as information relating to responses to user RFIs from targeted search result contacts of interest to the user 11.

The location database 26 stores information relating to map points previously selected by the user, specifically determining one of the following locations: the users work location, the users home location, or an alternative user location. The information stored in location database 26 is used by ranking module 18 to sort search results 30.

The listing database 28 stores information regarding each listing, including but not limited to contact information, advertisement information, business information, and other information pertaining to a listing.

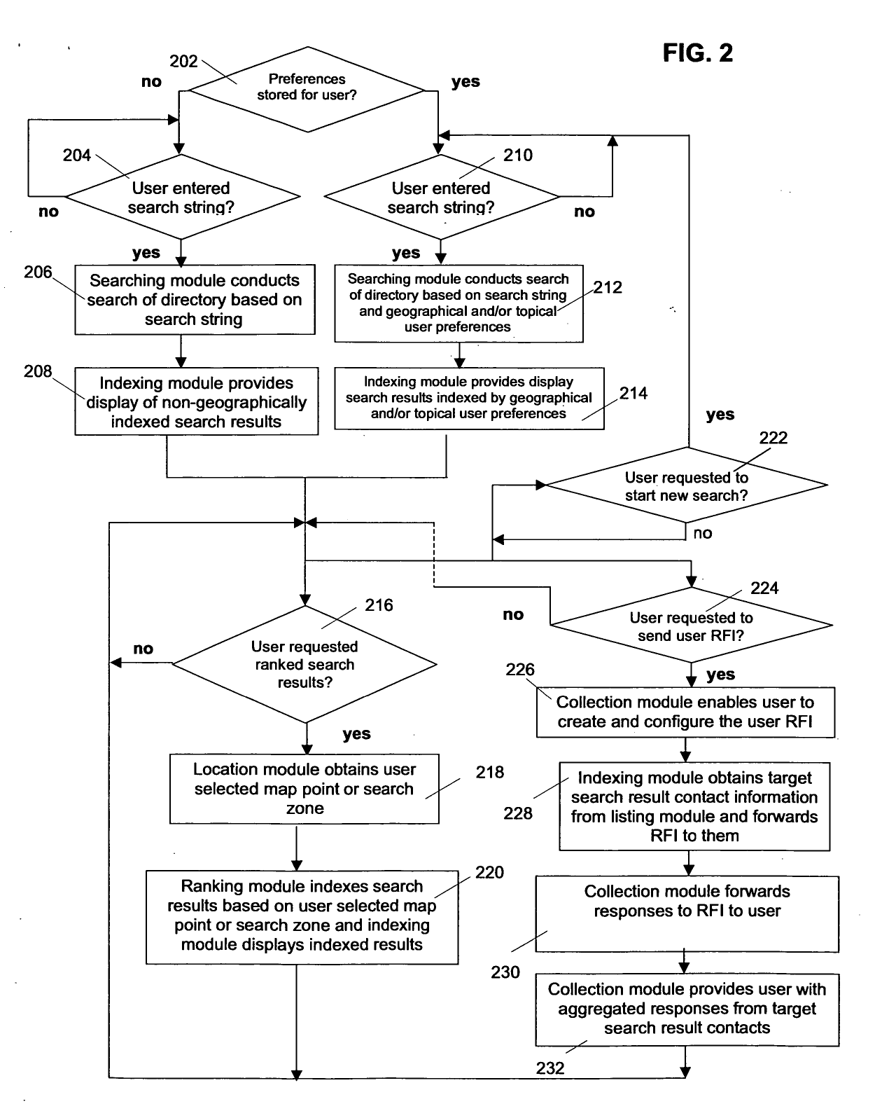

FIG. 2 is a flowchart which illustrates the basic operational steps conducted by geographical indexing system 10.

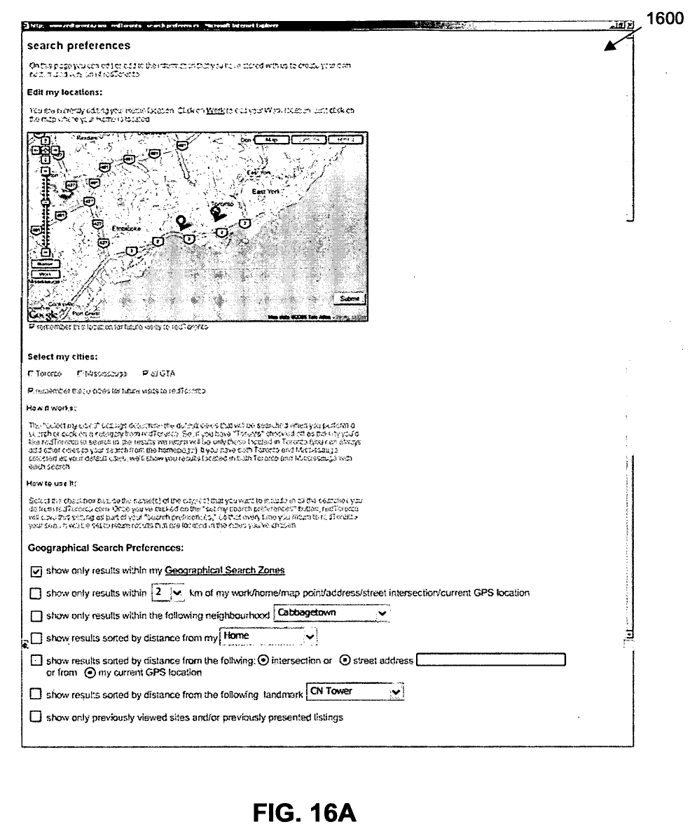

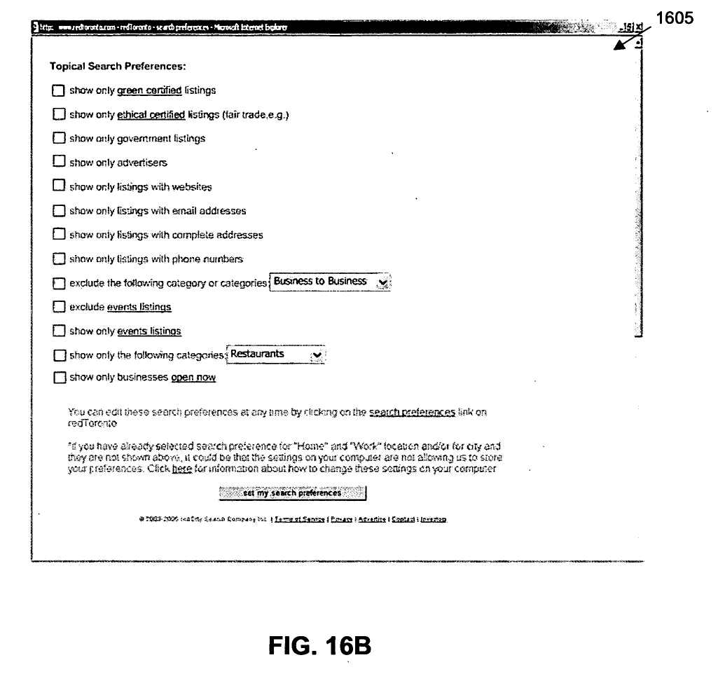

At step (202), indexing module 12 determines whether geographical indexing system 10 has any stored topical or geographical preferences (as configured in FIGS. 16A and 16B) for the user 11. If not, then at step (204), indexing module 12 determines whether the user 11 has entered a search string. If not, then indexing module 12 repeats this step.

If the user 11 has entered a search string, then at step (206), searching module 14 conducts a search of listing database 28 according to the search string provided by the user 11 and generates a set of search results 30.

At step (208), indexing module 12 provides a display of the non-geographically indexed search results 30 generated by the searching module 14 on user display 23 to the user 11.

If geographical indexing system 10 has stored topical or geographical preferences (as configured in FIGS. 16A and 16B) for the user 11, then at step (210), indexing module 12 determines whether the user 11 has entered a search string. If not, indexing module 12 repeats this step.

If the user 11 has entered a search string, then at step (212), searching module 14 conducts a search of listing database 28 according to the search string provided by the user 11, and refines results based on topical or geographical preferences stored for the user 11, and generates a set of search results 30.

At step (214), indexing module 12 provides a display of the search results 30, indexed by any relevant topical or geographical user preferences, generated by the searching module 14 on user display 23 to the user 11.

At step (216), indexing module 12 determines whether the user 11 has requested to rank non-geographically indexed search results 30 by proximity to a geographical location. If not, then indexing module 12 returns to the appropriate previous step of (208) or (214). If so, then at step (218), indexing module 12 utilizes location module 16 to obtain a user-selected map point.

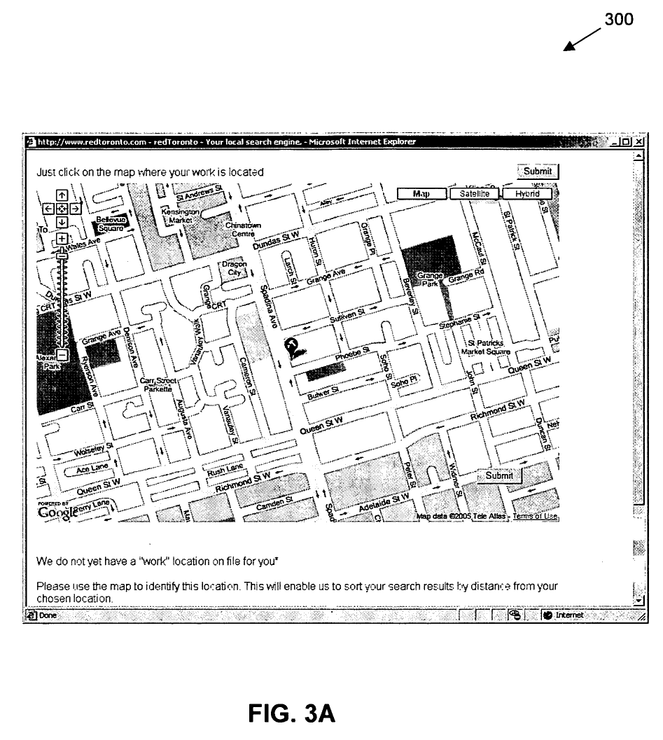

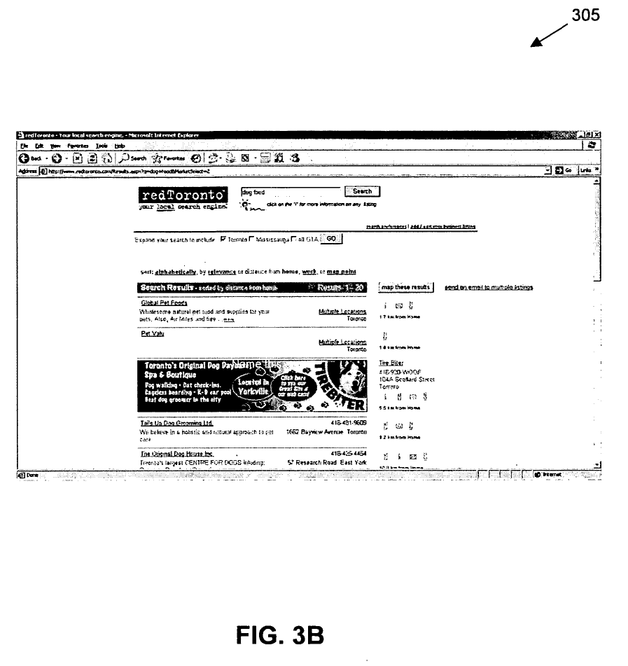

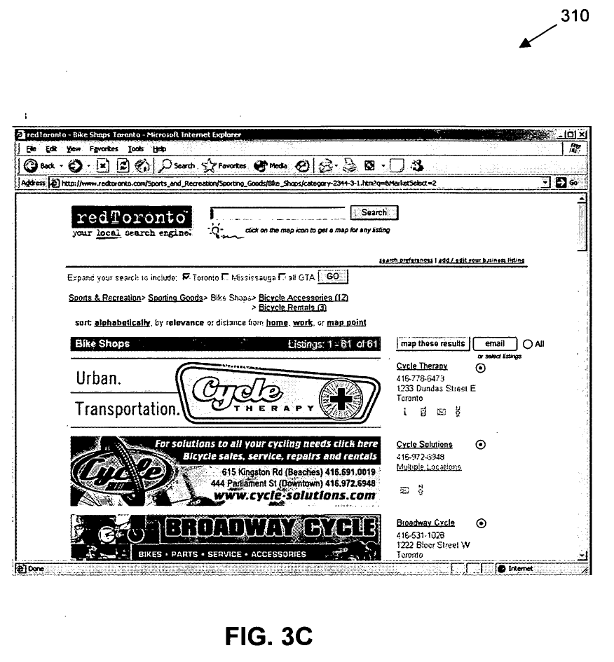

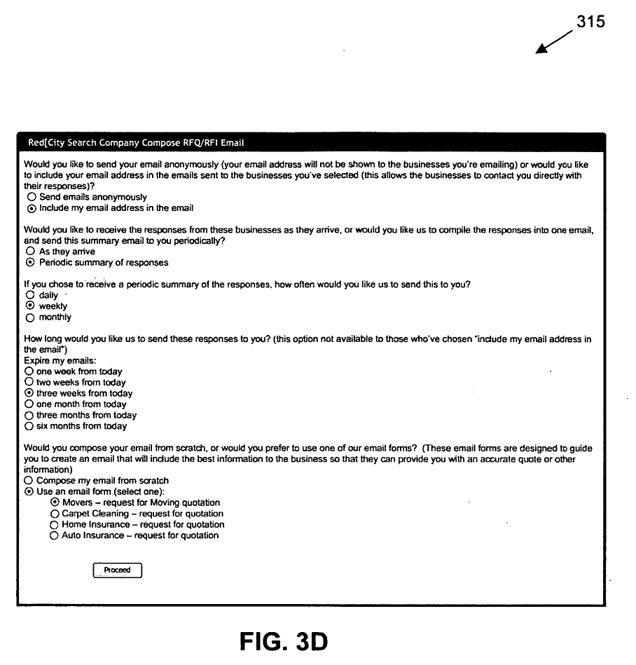

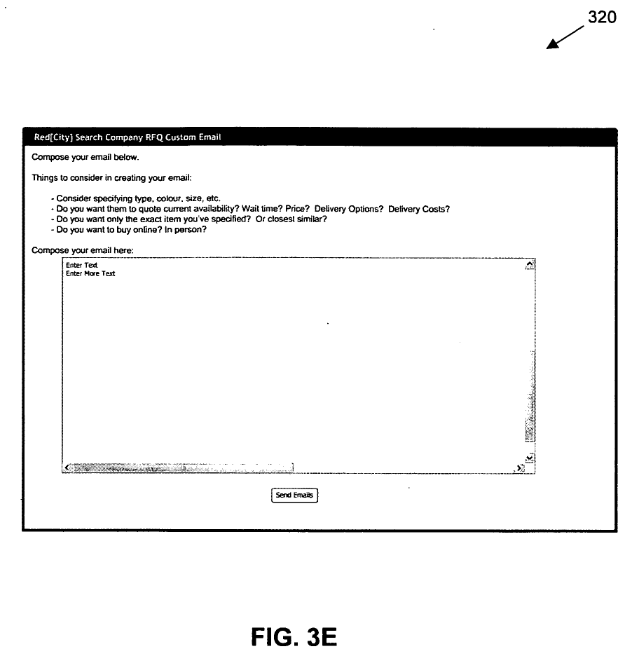

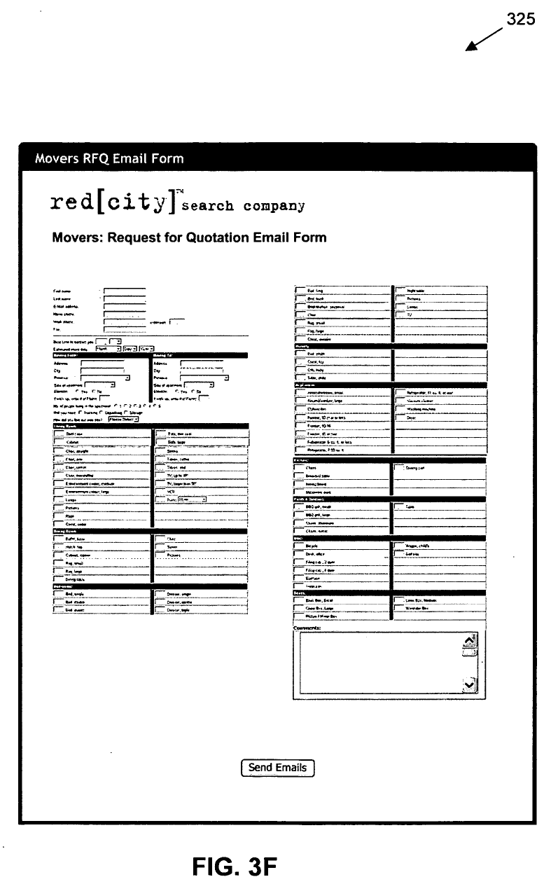

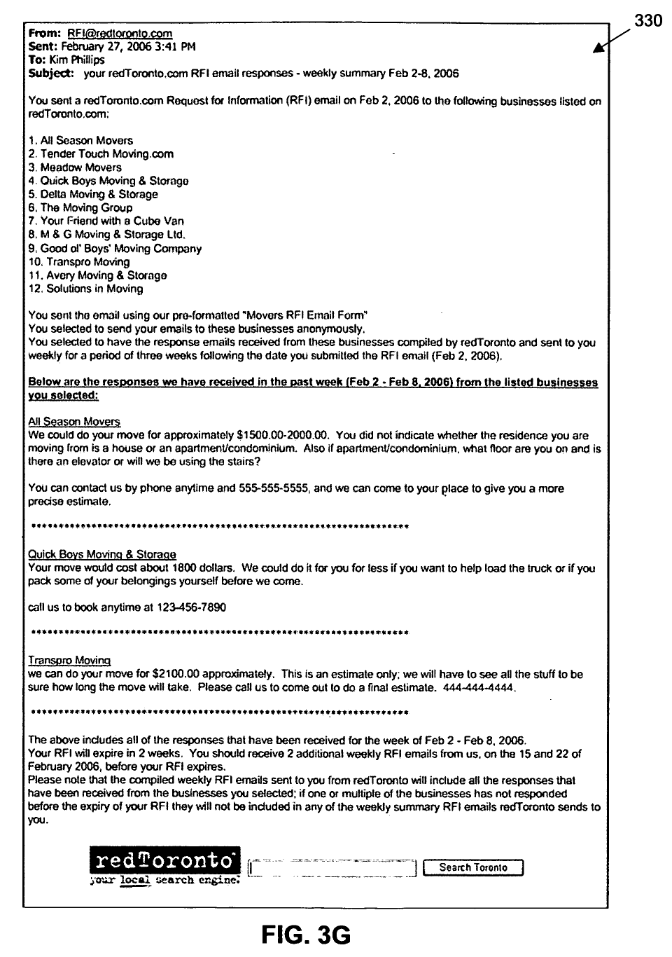

If there is a geographical location stored for the user-selected location in location database 26, location module 16 retrieves the geographical location from location database 26 and returns the geographical location to indexing module 12, which forwards the geographical location to ranking module 18. If there is no geographical location stored for the user-selected location in location database 26 for the user 11, then the user 11 submits a user-selected map point as illustrated in FIG. 3A, where the user 11 is presented with a graphical geographical map, and selects a point on the graphical geographical map, and location module 16 stores this location in location database 26.

At step (220), ranking module 18 indexes the non-geographically indexed search results 30 based on the user-selected map point and corresponding geographical location and sends the indexed search results 30 to indexing module 12 for display on user display 23 to the user 11, where the indexed search results 30 appear as illustrated in FIG. 3B.

At step (222), indexing module 12 determines whether the user has requested to start a new search. If so, the indexing module 12 returns to step (202).

At step (224), the indexing module 12 determines whether the user 11 has requested to send a user RFI to targeted search result contacts. If so, then at step (226), collection module 20 enables the user 11 to create and configure a user RFI.

At step (228), indexing module 12 obtains target search result contact information from listing database 28 utilizing listing module 22.

At step (230), collection module 20 collects and aggregates user RFI responses from target search results and at step (232), the collection module provides the user 11 with the aggregated or individually received responses from target search result contacts to which the user 11 sent the user RFI.

While the components of the geographical indexing system 10 described herein are depicted as separate elements, it should be understood that the indexing module 12, searching module 14, location module 16, ranking module 18, collection module 20 and listing module 22 may all be combined in different combinations, forming different modules providing the same function, as would be recognized by those skilled in the art. It should also be understood that the collection database 24, location database 26, and listing database 28 may reside on separate computer systems (e.g. on a PC or a server computer) or on the same computer system, and may be connected to each other and to the geographical indexing system 10 directly or indirectly (e.g. across a local network or the Internet). Alternatively, HTTP Magic Cookies™ could be used to store information or preferences instead of a centralized database.

It should be understood that the exemplary embodiments of the geographical indexing system 10 discussed within this disclosure are for illustrative purpose only and many variations on the specific implementations being discussed are possible. For example, while the geographical indexing system 10 described herein is discussed in relation to searching directory listings, it should be understood that the geographical indexing system 10 could be applied to any database system, as would be recognized by those skilled in the art.

FIG. 3A is a schematic diagram illustrating how the user-selected map point is determined by presenting the user with a graphical geographical map on which to select a map point. While the method of collecting user location information is illustrated as one component of an exemplary embodiment of geographical indexing system 10, it should be understood that this method could be implemented independent of geographical indexing system 10.

FIG. 3B is a schematic diagram illustrating how the search results 30 are ranked by proximity to the user-selected map point selected in FIG. 3A. Beside each search result is displayed the distance and/or direction from the user-selected location to the physical location of the search result as a hyperlink or, if no physical location exists for a search result, a message to that effect (e.g. “Distance data not available”). If the hyperlink is displayed, and the user clicks on the hyperlink, then the user is presented with a graphical geographical map indicating the user-selected location and the location of the search result.

FIG. 3C is a schematic diagram illustrating how the search results are displayed after the user has selected to send a user RFI. The search results are listed with selection buttons next to each, using which the user designates the target search result contacts of interest for the RFI. In another embodiment, selection buttons always appear next to search results, without the need for the user to specify their intent to send a user RFI.

FIG. 3D is a schematic diagram illustrating how a user RFI is configured. The user selects whether to have individual responses forwarded to the user as they are received, or to receive aggregated responses sent at regular intervals. If aggregated responses are chosen, the user selects how frequently to receive aggregated responses to their user RFI (e.g. daily, weekly, monthly, or as the responses are received). If the user chooses a frequency that is an interval (e.g. weekly), then user RFI responses are saved until the expiry of the interval, and aggregated into a single message sent by e-mail to the user, in the format illustrated in FIG. 3G. The user also selects whether to remain anonymous or to include their personal e-mail address in the user RFI. If the user chooses to remain anonymous, a temporary e-mail address (e.g. temp1@redCity.com) is created, and target contacts of interest respond to the temporary address.

The user also chooses a period of time after which their temporary e-mail address will expire. If the user chooses to include their personal e-mail address in the user RFI, then responses from target contacts of interest are sent to the user's personal e-mail address. In either case, all responses to user RFIs are saved in collection database 24. The user further selects whether to compose their own user RFI, as illustrated in FIG. 3E, or to create their user RFI from one of several existing templates, as illustrated in FIG. 3F. In either case, the user submits the content of their RFI and collection module 20 sends the RFI to indexing module 12 for distribution to the target contacts of interest.

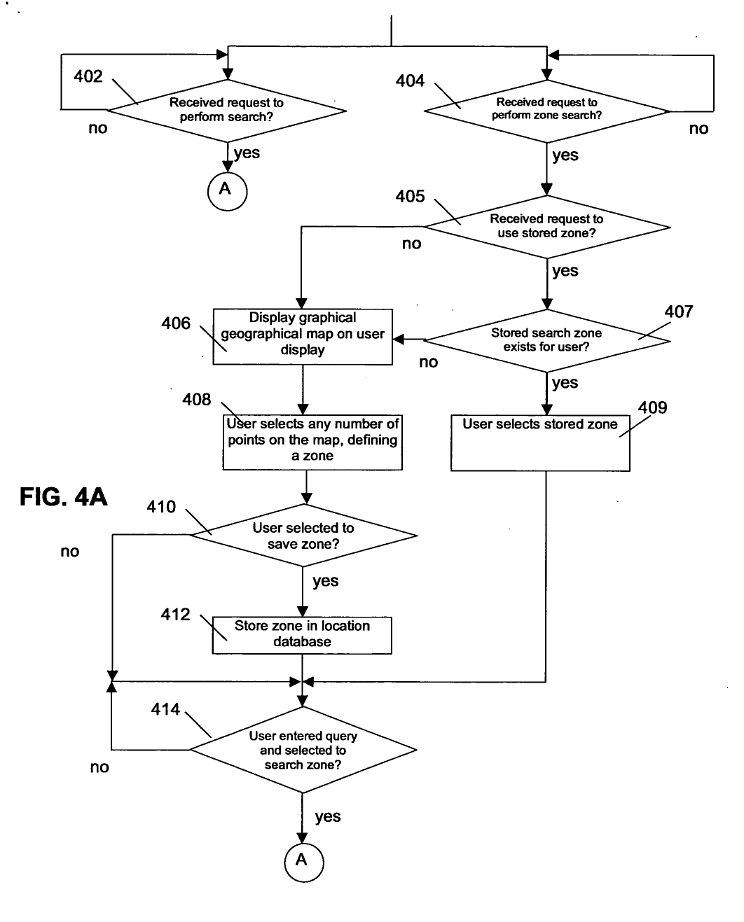

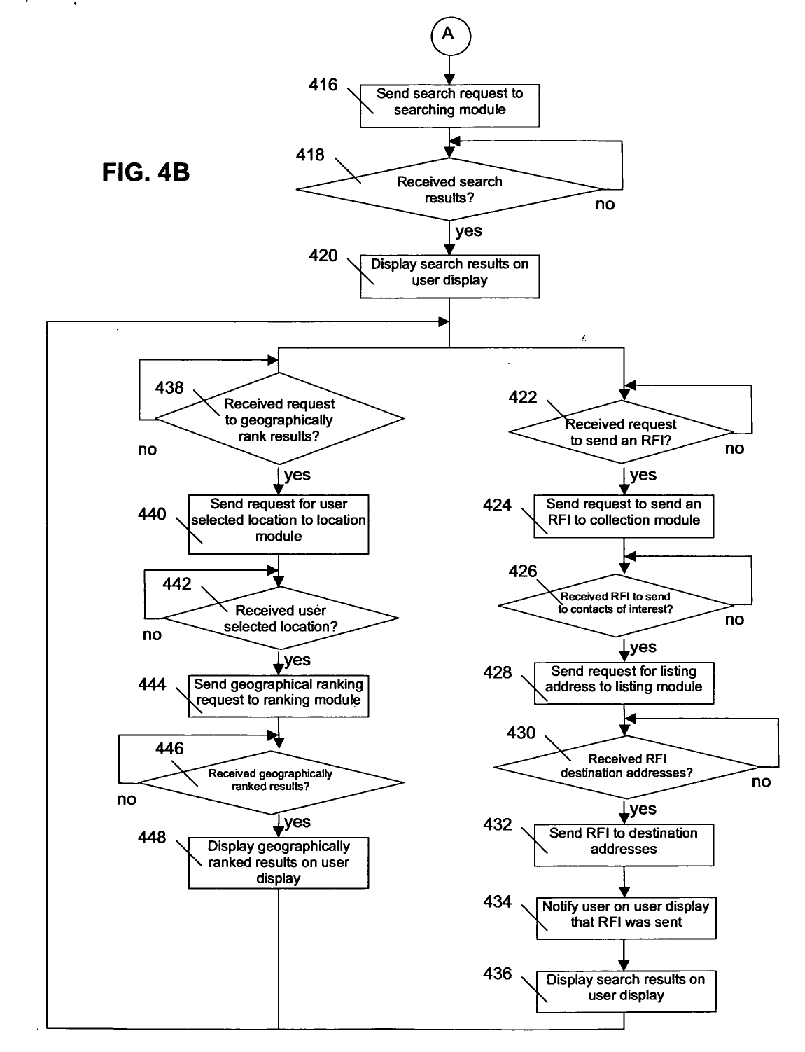

FIGS. 4A and 4B are flowcharts illustrating the operation of indexing module 12 of FIG. 1. Indexing module 12 accepts either a request to perform a regular search, or a request to perform a zone search.

A regular search comprises a search string containing terms defining search results 30 the user 11 wishes to find (e.g. “plumber in Toronto”). In one embodiment, this search string may include a term or terms describing a neighborhood (e.g. “Bloor-West Village”), such that geographical indexing system 10 presents only search results 30 in that neighborhood.

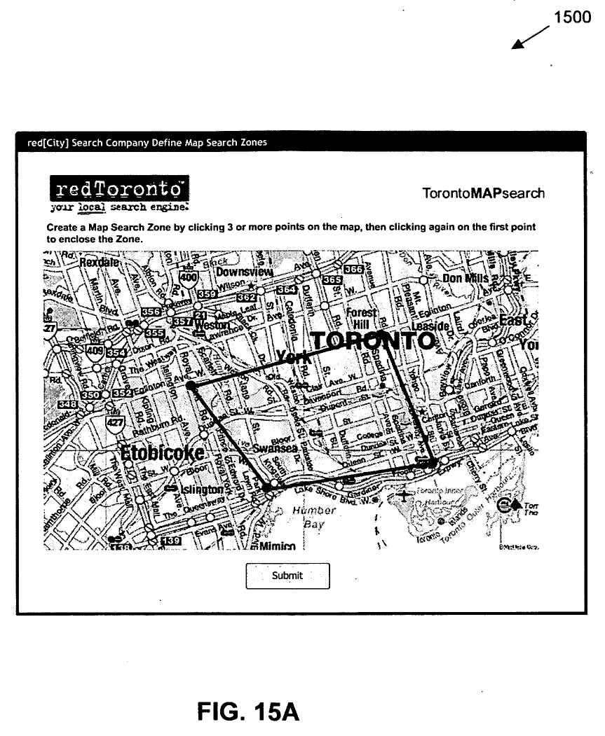

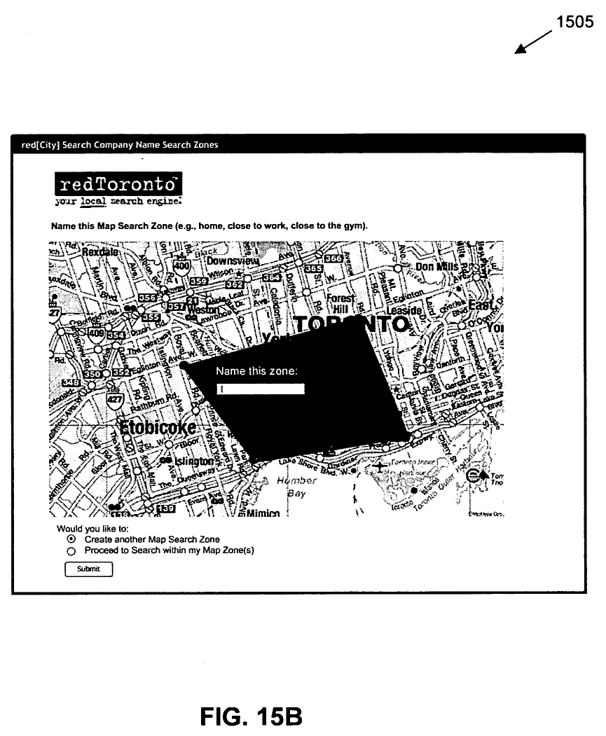

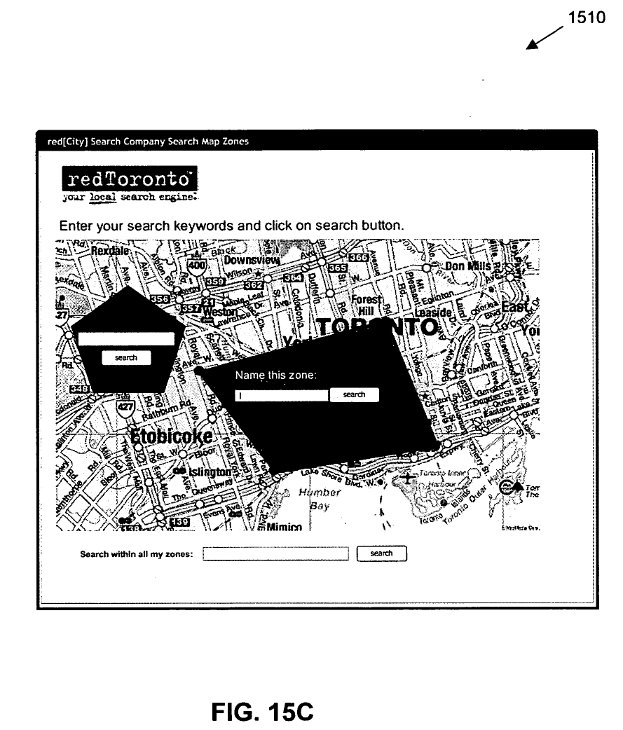

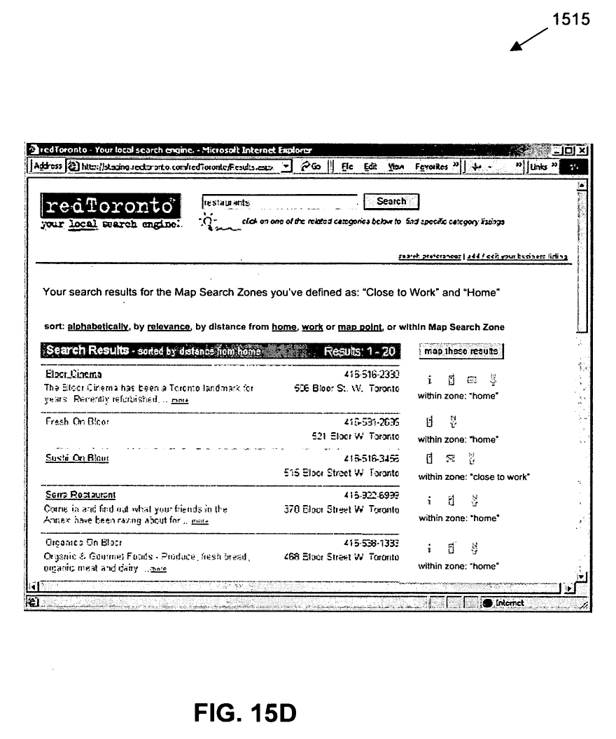

A zone search is a search for results whose geographic location is within a user-specified area. The user 11 specifies this area by selecting three or more points on a graphical geographical map, enclosing a geometric shape, as illustrated in FIG. 15A. A zone search only returns search results whose address, resolved to a geocode, is within one or more of the selected search zones. Search zones may be saved or used only once.

The user 11 may choose to refine any query or search results 30 to show only results located within at least one user-defined search zone. If the user 11 has previously stored search zones they may choose to use one of those stored search zones, or to create a new search zone. If the user 11 chooses a stored search zone by which to refine their search results, a new set of indexed search results will be shown, now including only those results whose address, resolved to geocode, is within one or more of the at least one user-selected search zones.

At step (402), indexing module 12 determines whether it has received a request to perform a regular search. If so, then indexing module 12 invokes step (416).

Alternatively, if indexing module 12 has received a request to perform a zone search, as determined at step (404), then at step (405), indexing module 12 determines whether the user 11 wishes to use a saved search zone. If so, then at step (407), indexing module 12 determines whether a stored search zone exists for the user 11. If so, the user 11 selects a stored search zone, as in step (409).

If the user 11 does not wish to use a stored search zone, or if the user 11 has no stored search zones, then at step (406), indexing module 12 displays a graphical geographical map to the user 11. The user 11 selects any number of points on the map, as described by step (408) and illustrated in FIG. 15A, forming any shape, and closing the shape by selecting the initial point again on the map. The user 11 is then prompted to save and name the newly formed zone, to define another zone, or to perform a search of the zones they have just created, as illustrated in FIG. 15B. Multiple search zones are displayed as illustrated in FIG. 15C.

At step (410), indexing module 12 determines whether the user has selected to save the search zone. If so, indexing module 12 saves the search zone to locations database 26.

In either case, at step (414), indexing module 12 accepts a search query from the user for the selected zone or all zones, as illustrated in FIG. 15C, and invokes step (416). At step (416), indexing module 12 sends a search request to searching module 14, which searches listings database 28 according to the search query and returns search results 30.

At step (418), indexing module 12 determines whether it has received search results 30 from searching module 14. If so, then at step (420), indexing module 12 displays search results 30 on user display 23, as illustrated in FIG. 15D, indicating in which zone each search result was located.

At this stage, the user 11 may request to geographically rank the search results, or to send a user RFI to search result contacts of interest. These functions may be performed in any order, any number of times.

At step (422) indexing module 12 determines whether the user 11 has requested to send a user RFI to search result contacts of interest. If so, then at step (424), indexing module 12 sends a request to send a user RFI to collection module 20, which allows the user to create and configure a user RFI and select search result contacts of interest who will receive the RFI, and waits for a response.

At step (426), indexing module 12 determines whether it has received a user-prepared RFI to be distributed to search result contacts of interest. If so, then at step (428), indexing module 12 sends a request for listing addresses to listing module 22, which searches listing database 28 for contact information (e.g. e-mail address) for contacts of interest, and waits for a response.

At step (430), indexing module 12 determines whether it has received the destination addresses of the search result contacts of interest for the user RFI. If so, then at step (432), indexing module 12 sends the RFI to the contacts of interest, and at step (434), indexing module 12 notifies the user 11 on user display 23 that the RFI has been sent to the requested search result contacts of interest, and at step (436), indexing module 12 displays the search results 30 as in step (420).

At this point, the user 11 may request to rank the results based on a geographical location, request to send another user RFI to search result contacts of interest, or begin a new search.

At step (438), indexing module 12 determines whether the user 11 has requested to geographically rank search results 30. If so, then at step (440), indexing module 12 sends a request for a user-selected location to location module 16 and waits for a response.

At step (442), indexing module 12 determines whether it has received a user-selected location from location module 12. If so, then at step (444), indexing module 12 sends a geographical ranking request to ranking module 18 and waits for a response.

At step (446), indexing module 12 determines whether it has received geographically ranked results from ranking module 18. If so, then at step (448), indexing module 12 displays the geographically ranked search results 30 on user display 23, as illustrated in FIG. 3B.

At this point, the user 11 may request to rank the search results based on a different geographical location, to send a user RFI to search result contacts of interest, or to begin a new search.

While the method of sending a user RFI is illustrated as one component of an exemplary embodiment of geographical indexing system 10, it should be understood that this method could be implemented independent of geographical indexing system 10.

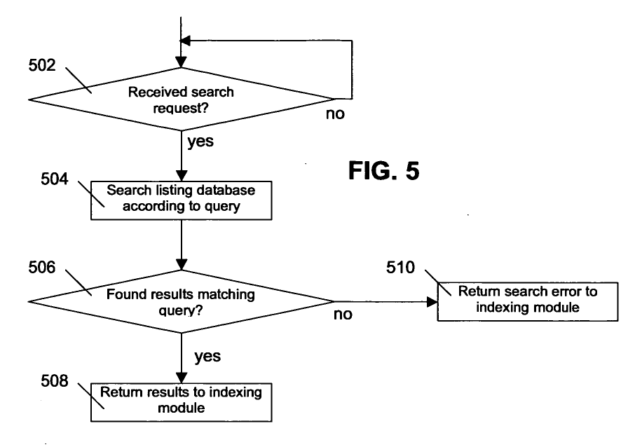

FIG. 5 is a flowchart illustrating the operation of searching module 14 of FIG. 1. At step (502), searching module 14 determines whether it has received a search request from indexing module 12. If so, then at step (504), searching module 14 searches listing database 28 according to the user query.

At step (506), searching module 14 determines whether the search of listing database 28 yielded any search results 30. If so, then at step (508), searching module 14 returns those search results 30 to indexing module 12. If not, then at step (510) searching module 14 returns an error to indexing module 12 expressing the fact that there were no search results 30 found in listing database 28 matching the query.

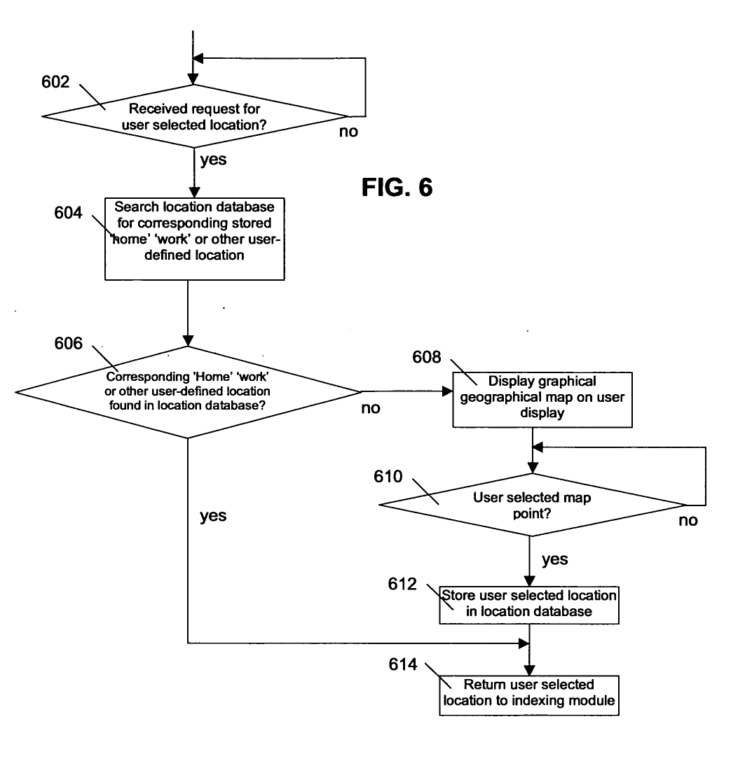

FIG. 6 is a flowchart illustrating the operation of location module 16 of FIG. 1. At step (602), location module 16 determines whether it has received a request for a user-selected location from indexing module 12. If so, then at step (604) location module 16 searches location database 26 for a saved map point corresponding to the user-selected location requested by the user 11, if one exists.

If a map point exists for the user 11 in location database 26, as determined at step (606), then at step (614), location module 16 returns the user-selected location from location database 26 to indexing module 12.

If no map point exists for the user 11 in location database 26, then at step (608), location module 16 displays a graphical geographical map on user display 23, upon which the user 11 selects a map point, as illustrated in FIG. 3A. Once the user selects a map point, as determined in step (610), then at step (612), location module 16 stores the user-selected location in location database 26, and at step (614) returns the user-selected location to indexing module 12.

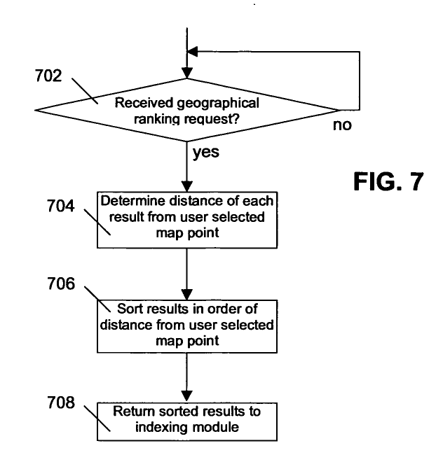

FIG. 7 is a flowchart illustrating the operation of ranking module 18 of FIG. 1. At step (702), ranking module 18 determines whether it has received a geographical ranking request from indexing module 12. If so, then at step (704), ranking module 18 determines the distance from the user-selected location determined by location module 16 of each of the search results 30 found by searching module 14.

At step (706) ranking module sorts the results according to their distance from the user-selected location.

At step (708), ranking module 18 returns the sorted results to indexing module 12 for display to the user 11 on user display 23.

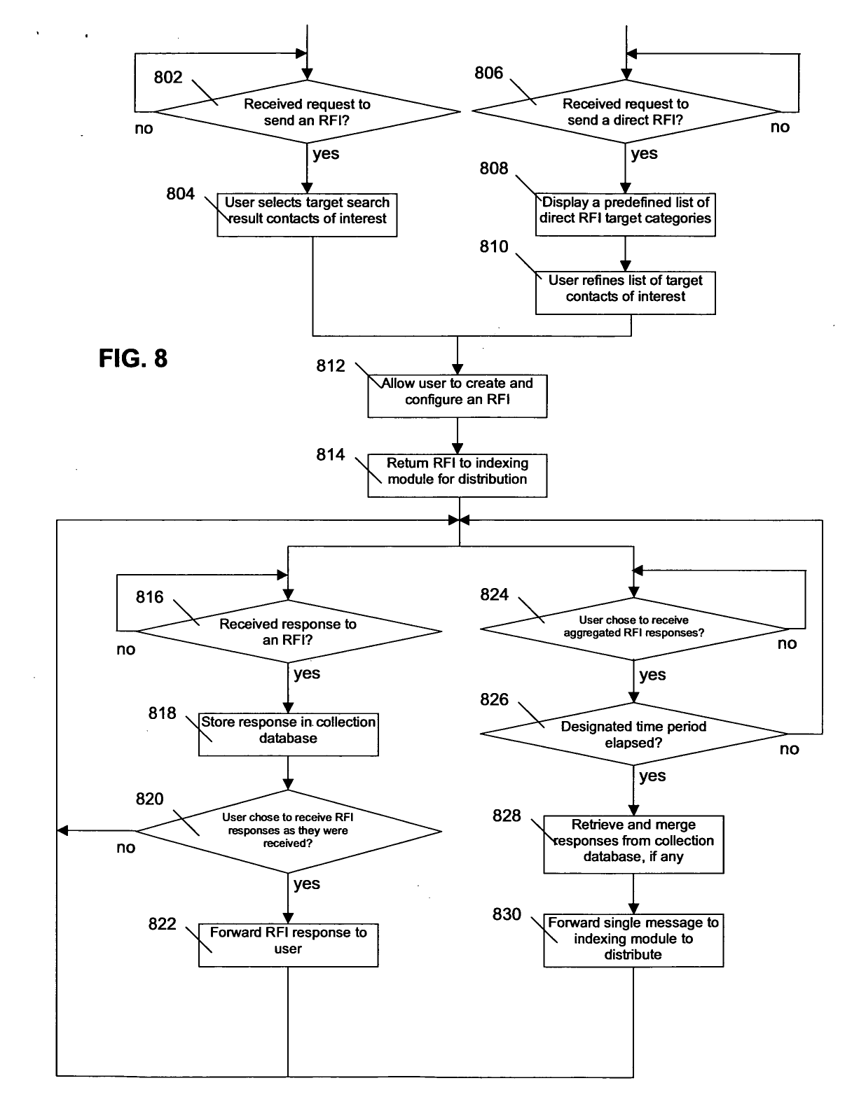

FIG. 8 is a flowchart illustrating the operation of collection module 20 of FIG. 1. A user 11 may send an e-mail user RFI through two different channels: regular (sent to target search results) and direct (sent to a target category). A regular e-mail user RFI is created by performing a search, and selecting target contacts of interest from the search results, as illustrated in FIG. 3C. A direct e-mail user RFI is created by selecting a target category (e.g. plumbers@redCity.com) from a list of predefined categories (not shown).

While these methods of sending a user RFI are illustrated as components of an exemplary embodiment of geographical indexing system 10, it should be understood that these method could be implemented independent of geographical indexing system 10.

At step (802), collection module 20 determines whether it has received a request to send a user RFI from indexing module 12. If so, then at step (804), the user 11 selects target search result contacts of interest for the user RFI, as illustrated in FIG. 3C. Alternatively, at step (806), if collection module 20 receives a request from the user 11 to send a direct RFI, then at step (808), collection module 20 displays a predefined list of target categories, from which the user 11 may choose to refine a list of target contacts of interest by geographical sorting or zone searching (not shown).

In either case, at step (812), collection module 20 allows the user 11 to create and configure a user RFI, including message contents and target search result contacts of interest, as illustrated in FIGS. 3C, 3D, 3E, 3F and 3G.

At step (814), collection module 20 returns this RFI to indexing module 12 for distribution to the specified contacts of interest.

At this point, collection module 20 may either receive a response to a user RFI from a target search result contact of interest, or the designated time period to collect responses can elapse.

If collection module 20 receives a response to a user RFI, as determined in step (816), then at step (818), collection module 20 stores the response in collection database 24. Additionally, at step (820), collection module 20 determines whether the user 11 chose to receive RFI responses as they are received by collection module 20. If so, then at step (822), collection module 20 forwards the user RFI response to the user 11 and returns to step (814), and may either receive more RFI responses or wait for the next time period to elapse.

At step (824), collection module 20 determines whether the user chose to receive aggregated responses. If so, then at step (826), collection module 20 determines whether the designated time period for collecting responses has elapsed (e.g. one day, one week), as configured in FIG. 3D, collection module 20 retrieves the responses collected to date, if any, from collection database 24, and aggregates the retrieved responses, if any, into a single message, as illustrated in FIG. 3G. as designated at step (828).

At step (830), collection module 20 sends this single message to indexing module 12 for distribution to the user 11. At this point collection module 20 returns to step (814), and may either receive more RFI responses or wait for the next time period to elapse.

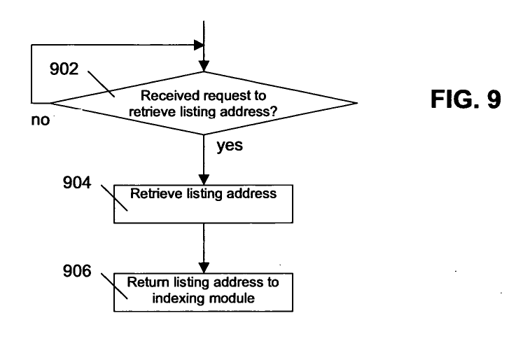

FIG. 9 is a flowchart illustrating the operation of listing module 22 of FIG. 1. Listing module 22 retrieves listing information (e.g. address) from listing database 28.

At step (902), listing module 22 determines whether it has received a request from indexing module 12 to retrieve a listing address from listing database 28. If so, then at step (904), listing module 22 retrieves the listing address from the listing database 28 and at step (906), listing module 22 returns the listing address to indexing module 12.

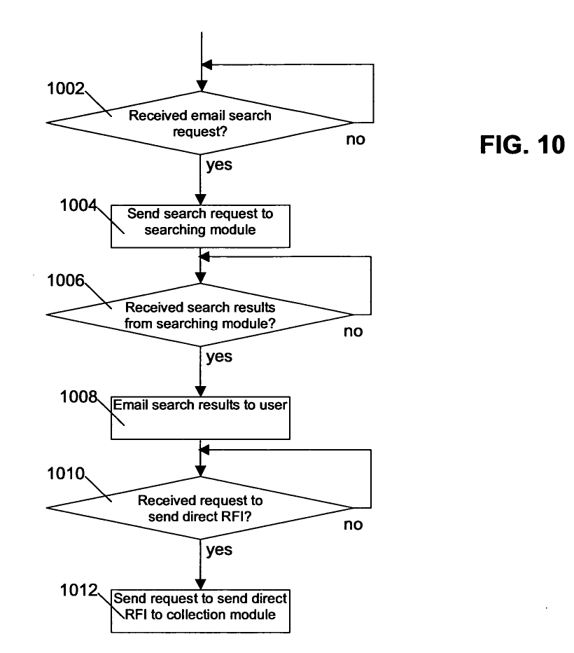

FIG. 10 is a flowchart illustrating the operation of geographical indexing system 10 of FIG. 1 in response to receipt of a search request by e-mail. In one embodiment, the user 11 submits a query by e-mail to a specific address (e.g. “search@redCity.com”), where the subject line (e.g. “fire wood”) is the query. In another embodiment, the user submits a query by sending a blank e-mail where the e-mail address contains the query (e.g. fire.wood@redCity.com).

While the method of searching by e-mail is illustrated as one component of an exemplary embodiment of geographical indexing system 10, it should be understood that this method could be implemented independent of geographical indexing system 10.

At step (1002), geographical indexing system 10 determines whether it has received a search request from the user 11 by e-mail. If so, then at step (1004), geographical indexing system 10 sends a search request to searching module 14 and waits for a response.

At step (1006), geographical indexing system 10 determines whether it has received search results from searching module 14. If so, geographical indexing system 10 sends an e-mail to the user 11 containing the search results 30 in a format corresponding to the format of the initial e-mail search request (e.g. if the query e-mail was written in HTML, then the search results will be sent in HTML), with a subject line notifying the user of the contents of the e-mail. Additionally, if the query was a direct match with a category (in which case a predetermined set of category results is returned to the user) then the user is presented with the option to send an RFI to the search results 30, in the form of a hyperlink to the direct RFI function described in FIG. 8.

At step (1010), geographical indexing system 10 determines whether it has received a request from the user 11 to send a direct RFI. If so, then at step (1012), geographical indexing system 10 sends a request to send a direct RFI to collection module 20.

While the method of sending a direct user RFI is illustrated as one component of an exemplary embodiment of geographical indexing system 10, it should be understood that this method could be implemented independently of geographical indexing system 10.

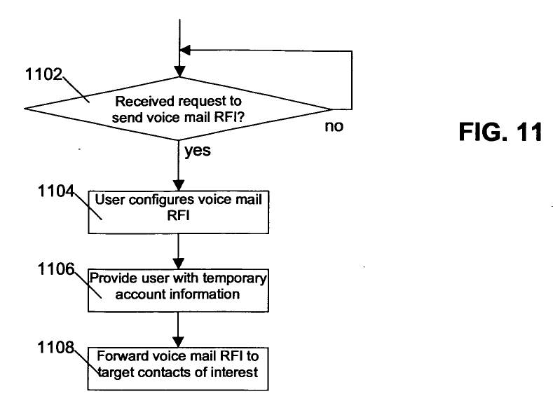

FIG. 11 is a flowchart illustrating the operation of geographical indexing system 10 of FIG. 1 in response to receipt of a request to send an RFI by voice mail. In one embodiment, the user 11 places a telephone call to a phone number assigned to a category. Once the user 11 is connected to the geographical indexing system 10, the user 11 hears a pre-recorded message prompting them to configure their voice mail RFI.

While the method of sending a voicemail user RFI is illustrated as one component of an exemplary embodiment of geographical indexing system 10, it should be understood that this method could be implemented independently of geographical indexing system 10.

At step (1104), the user 11 configures and creates a vocal RFI message for all contacts in the selected category, which may include instructions to contact the user 11 directly, through a temporary voice mail box, or through e-mail to a temporary e-mail account.

At step (1106), the user 11 is provided with the account information for the temporary account at which the user will retrieve their responses, if they requested a temporary voice mail box or e-mail account.

At step (1108), geographical indexing system 10 forwards the voice mail RFI to target contacts in the selected category.

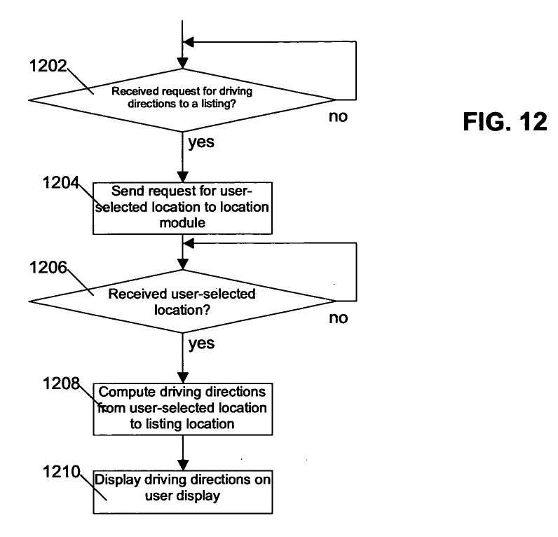

FIG. 12 is a flowchart illustrating the operation of geographical indexing system 10 of FIG. 1 in response to receipt of a request for driving directions. Driving directions determine a path, preferably the optimal path, between a start location (e.g. the user's home location) and an end location (e.g. a listing's physical location). In one embodiment, start and end locations can be reversed, providing directions from an end location to a start location.

While the method of obtaining driving directions is illustrated as one component of an exemplary embodiment of geographical indexing system 10, it should be understood that this method could be implemented independently of geographical indexing system 10.

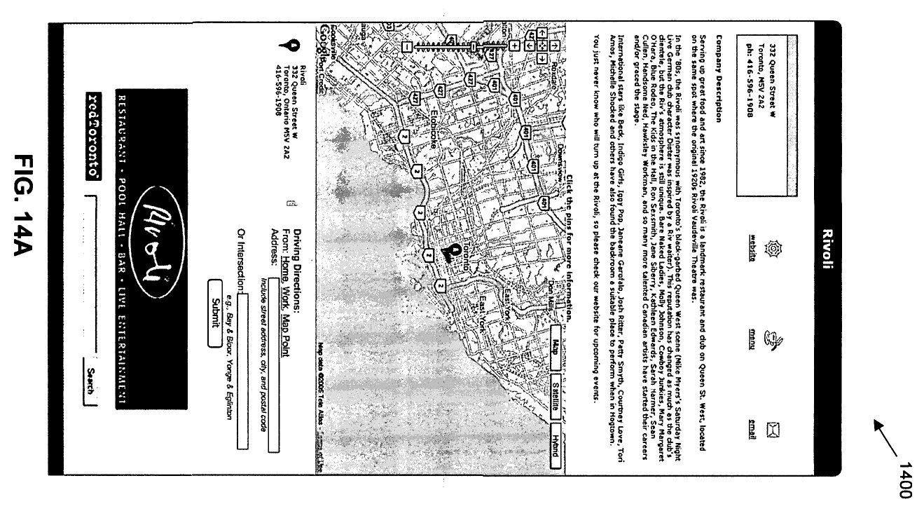

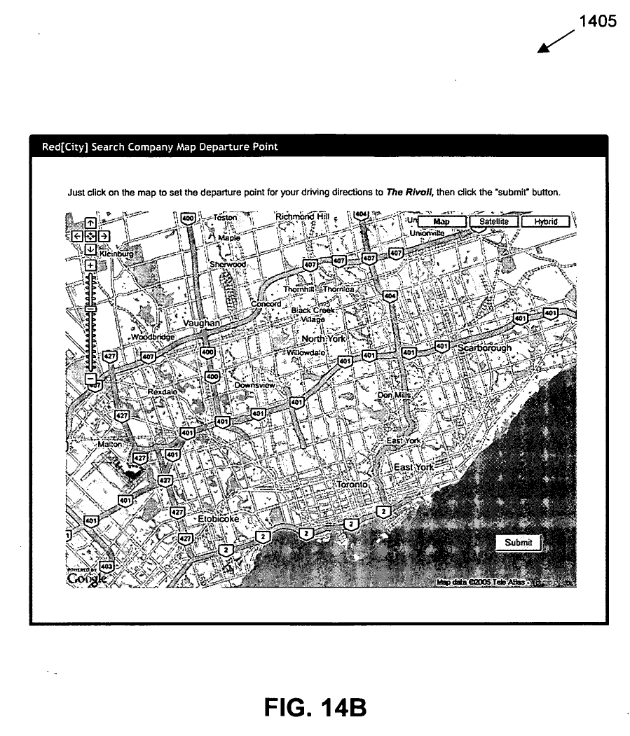

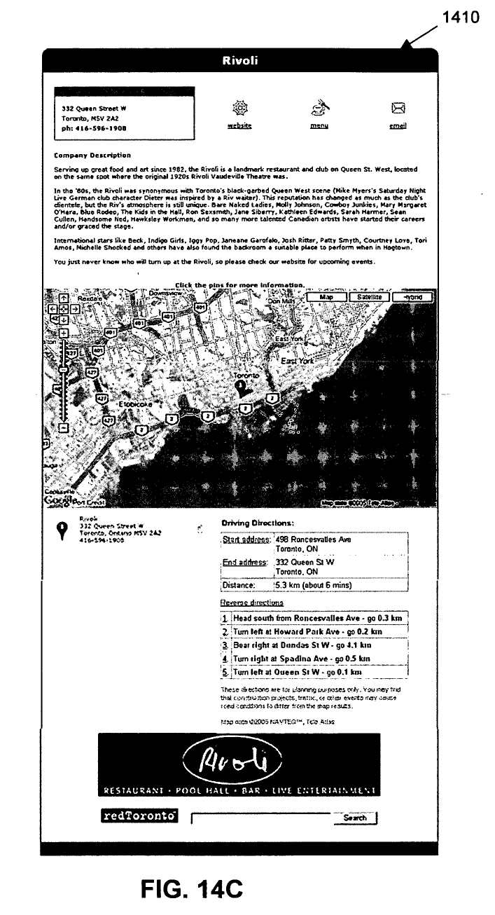

Each listing in listing database 28 has a detailed view associated with it, as illustrated in FIG. 14A. For any listing with a physical address, the detailed view includes the option to obtain driving directions to the physical address of the listing.

At step (1202), geographical indexing system 10 determines whether it has received a request for driving directions to a listing. If so, then at step (1204), geographical indexing system 10 sends a request for a user-selected location to location module 16, which start location information from the user 11 as illustrated in FIG. 14B, and waits for a response.

At step (1206), geographical indexing system 10 determines whether it has received a user-selected location from location module 16. If so, then at step (1208), geographical indexing system 10 computes driving directions from the user-selected location to the listing's physical location, and at step (1210), geographical indexing system 10 displays the driving directions to the user 11 on user display 23, as part of the detailed view illustrated in FIG. 14C.

In another embodiment, the user may also enter the user-selected location as an address. In yet another embodiment, the user may enter the user-selected location as a street intersection, or select a street intersection from a list. In yet another embodiment, the user may enter the user-selected location as the name of a landmark, or choose the name of a landmark from a list.

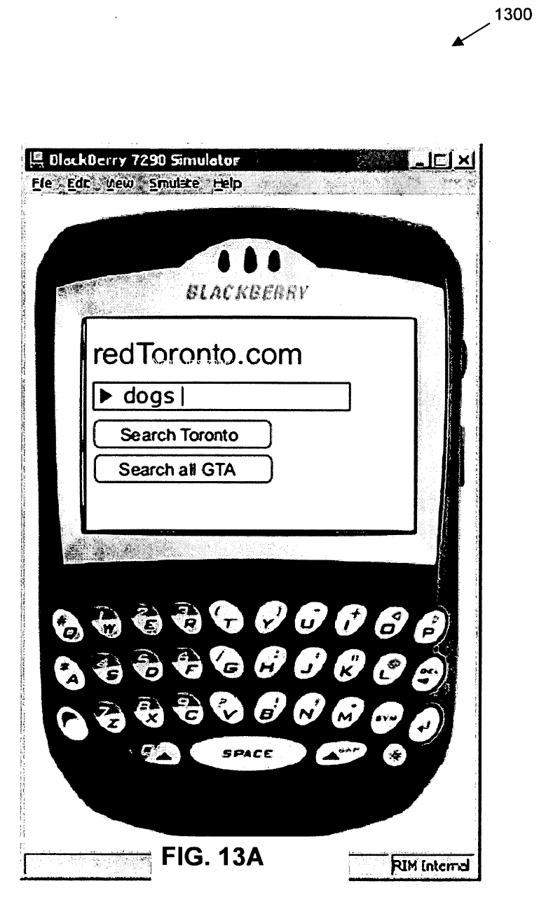

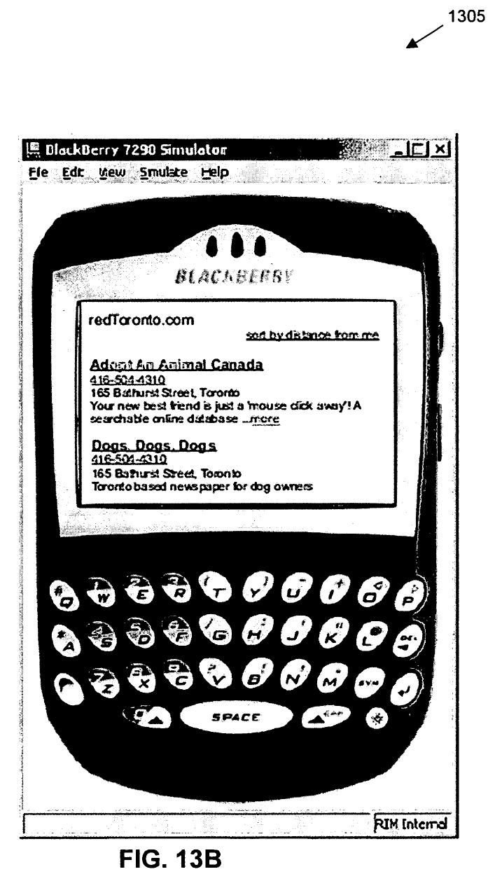

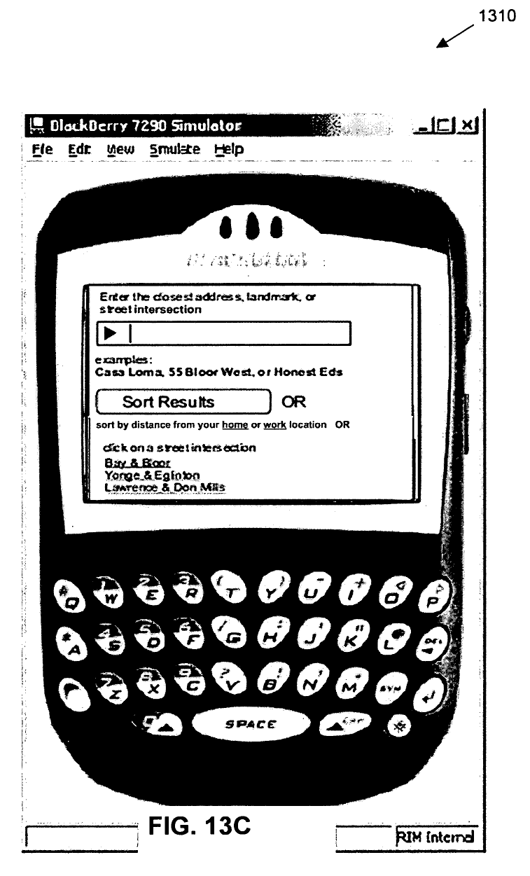

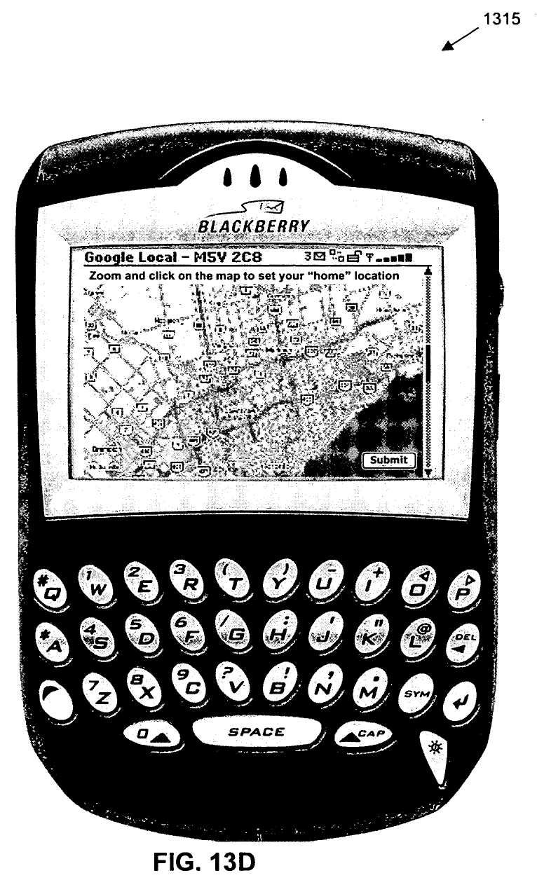

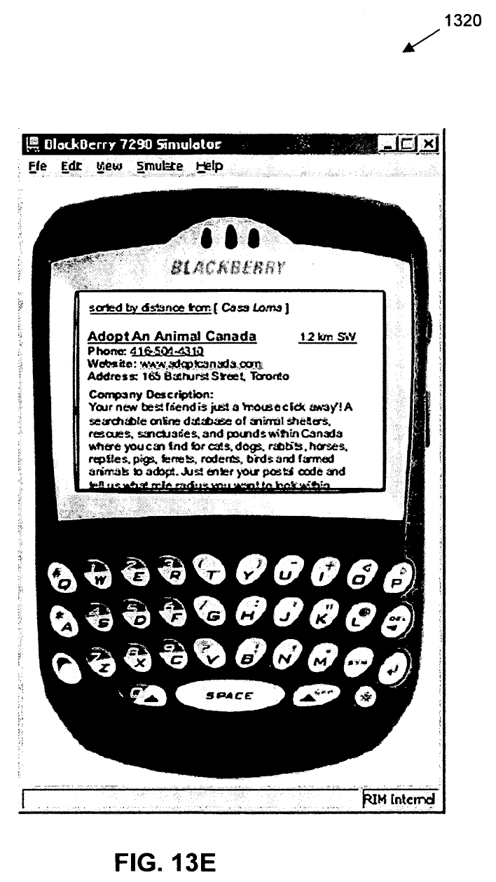

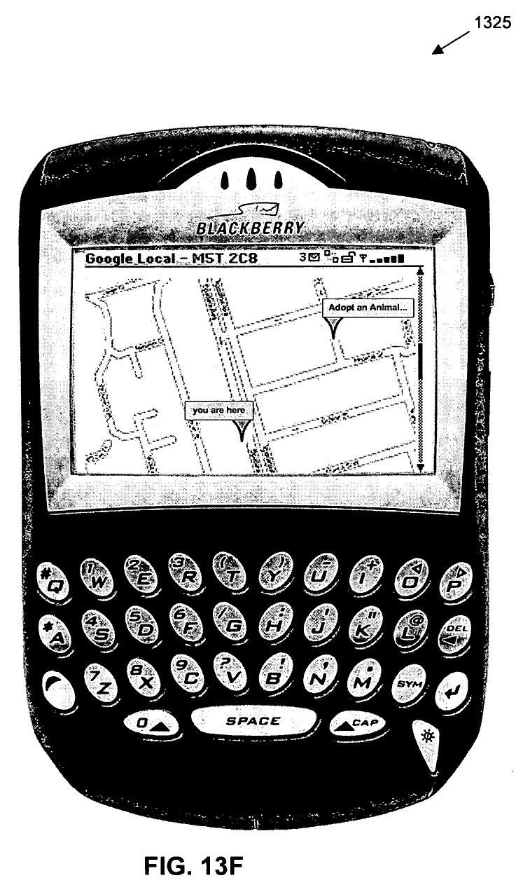

It will be appreciated that any of the features of the embodiment described herein may be accessed by any computing device, and displayed on any user display 23, including wired or wireless mobile devices, with or without WAP or GPS technology. FIG. 13A illustrates a search from a mobile device with a graphical display, while FIG. 13B illustrates the display of the corresponding search results 30. Where the mobile device display is contains touch sensors or a mouse device, a map point may be collected from the user using a graphical geographical map as illustrated in FIG. 13D.

Otherwise, a map point may be gathered using textual input, as illustrated in FIG. 13C, or determined automatically by the device using GPS or another technology (e.g. the user 11 may choose to sort search results 30 by distance from the device). Search results 30 are ranked and presented on the mobile device display as illustrated in FIG. 13E. Any of the search results 30 with physical addresses may be shown on a graphical geographical map as illustrated in FIG. 3F.

Alternatively, geographical indexing system 10 may be accessed by GPS-enabled devices or publicly located Internet kiosks or other devices. These devices may offer additional capability of sorting results by distance from the device, where the device sends its location to the geographical indexing system with each query and without intervention from the user 11. Such a device may automatically or may, with one click performed by the user, sort results by proximity to the device. These devices may also provide the capability to obtain driving directions from their current location, by sending their location with the user query to geographical indexing system 10. While these features are a selection of possible functionality accessible to mobile devices, any mobile device may in theory access any feature of geographical indexing system 10.

FIG. 14A is a schematic diagram illustrating how a detailed view for a search result is presented to a user. The detailed view includes all available data from listing database 28 associated with a specific listing. Details may include physical address, website address, e-mail address, company description, phone number, and a map. For any listing with a physical address, driving directions may be obtained using a start point previously stored in location database 26, or by selecting a start point on a graphical geographical map, as illustrated in FIG. 14B, or by entering a street address, street intersection, as illustrated in FIG. 4A, or a landmark location, or a current GPS location, as other examples. Driving directions are determined by geographical indexing system 10 and displayed in the detailed view, as illustrated in FIG. 14C.

FIG. 15A is a schematic diagram illustrating how a search zone is defined by selecting points on a graphical geographical map within geographical indexing system of FIG. 1;

FIG. 15B is a schematic diagram illustrating how a search zone is named within geographical indexing system 10.

FIG. 15C is a schematic diagram illustrating how multiple search zones are displayed and searched within geographical indexing system 10.

FIG. 15D is a schematic diagram illustrating how search results are displayed after a zone search within geographical indexing system 10.

While the method of searching or refining search results by designating a zone is illustrated as one component of an exemplary embodiment of geographical indexing system 10, it should be understood that this method could be implemented independent of geographical indexing system 10.

FIG. 16A is a schematic diagram illustrating how geographical user preferences are configured. Stored geographical preferences may include to show only results within selected search zones or neighborhoods, results within a certain distance from a map point, address, intersection or other location, or results that have been viewed before, for example. Stored geographical preferences may also include to sort results by distance from a map point, intersection, address, landmark or other location, for example. The user 11 may select to store these preferences for use in all future searches, or just for a current session. Additionally, any of these preferences may be set for only the current search by allowing the user 11 to select the preference at the time of submitting a search to searching module 14.

While the method of storing geographical preferences is illustrated as one component of an exemplary embodiment of geographical indexing system 10, it should be understood that this method could be implemented independent of geographical indexing system 10.

FIG. 16B is a schematic diagram illustrating how topical user preferences are configured. Stored topical preferences may include to search only environmentally friendly, ethical, advertiser, event or government listings, or listings within a certain class (e.g. businesses that are currently open), for example. Stored topical preferences may also include to search only listings with websites, e-mail addresses, complete addresses or phone numbers, for example. Stored topical preferences may also exclude certain categories or listing types from searches. The user 11 may select to store these preferences for use in all future searches, or just for a current session. Additionally, any of these preferences may be set for only the current search by allowing the user 11 to select the preference at the time of submitting a search to searching module 14.

While the method of storing topical preferences is illustrated as one component of an exemplary embodiment of geographical indexing system 10, it should be understood that this method could be implemented independent of geographical indexing system 10.

It will be appreciated that the methods of storing topical and geographical preferences described herein may have uses other than for localized searching. For example, topical or geographical preferences of users can be correlated to form topical or geographical groups, accordingly. Based on their preferences, different users may see different search results 30 or interface options.

Moreover, advertisers in a directory may pay to be displayed at a certain place in the search results list for specific topical or geographical groups (e.g. a dental practitioner in downtown Toronto may pay to be listed as the first search result for users browsing the category ‘Dentists’, and/or for users whose user-selected map point, map search zone, or other geographical preference area is in downtown Toronto, and/or only for users 11 whose search was specifically for dentists in downtown Toronto). The advertiser can choose target topical or geographical preference groups, and/or target current device locations (e.g. the originating location of a search), optionally through an interface.

In conventional search engines, the component or components performing the equivalent function to the location module 16 require the user 11 to follow a series of steps in which the user 11 provides various details about their desired geographical location (e.g. city, address, postal code). In this exemplary embodiment, the user 11 is presented with a graphical geographical map and, in one step, submits all required information about their location as a geographical map point.

The method of gathering geographical information described in this exemplary embodiment is a significant improvement over existing methods because it is faster and simpler than entering location information into multiple fields, and does not require the user to know the street address or postal code of the user-selected location. therefore achieves superior user friendliness compared to existing methods. It will be appreciated that the method described herein for gathering user location by graphical geographical map may have alternative uses related to localized searching.

Conventional search engines may provide contact information for search results. However, none contain a mechanism for sending the same communication to multiple target search result contacts of interest, as in the case for obtaining information about a product or obtaining a price quote on a product provided by a business. The exemplary embodiment described herein discloses a system for the user 11 to create user RFIs and send them to contacts of interest. This exemplary embodiment also describes a system for collecting responses from target contacts of interest to whom the user 11 sent a user RFI, merging those responses, and sending them to the user on predefined intervals (e.g. daily, weekly). In this regard this exemplary embodiment represents a distinct improvement over existing search engines and directories.

The exemplary embodiments described herein significantly overcome the obstacle of user-friendliness. In particular, the exemplary embodiments described herein disclose a method of gathering geographical location information from the user using a graphical geographical map, on which the user selects their location.

The exemplary embodiments described herein also significantly overcome the obstacle of communication between users and businesses represented in local search results. In particular, the exemplary embodiments described herein disclose a method for the user to send e-mail messages or other messages to contacts of interest, determined from search results provided by the localized search engine. The exemplary embodiments described herein also disclose a method of collecting responses from contacts of interest and communicating those responses to the user.

It will be appreciated that while the present invention has been described in the context of various methods including a geographical indexing method, the system, processes and methods of the present invention are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, Internet transmission or downloadings, magnetic and electronic storage media, digital and analog signals, and the like. The computer useable instructions may also be in various forms, including compiled and non-compiled code.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A geographical indexing system for use in association with a plurality of search results, said geographical indexing system comprising:
(a) a memory for storing a user-selected location;
(b) a processor coupled to the memory for:
(i) obtaining the user-selected location by:
(I) providing a user with a graphical geographical map;
(II) receiving the user-selected location as selected by the user on the graphical geographical map; and
(ii) indexing the plurality of search results based on the user-selected location.

2. The geographical indexing system of claim 1, the processor further performs an action selected from the group consisting of: displaying the indexed search results from (ii), storing the indexed search results from (ii), forwarding the indexed search results from (ii).

3. The geographical indexing system of claim 1, wherein the user-selected location is selected from the group consisting of: the user's work location, the user's home location, alternative user location, a user GPS position, a street intersection, a street address, a landmark location, a neighbourhood, and a user-defined geographical zone.

4. The geographical indexing system of claim 1, wherein one or more of the previous user-selected locations are displayed on the graphical geographical map.

5. The geographical indexing system of claim 1, wherein one or more of the indexed search results are displayed on the graphical geographical map.

6. The geographical indexing system of claim 1, further comprising a mobile device, wherein one or more of the indexed search results are sent to the mobile device using a method selected from the group consisting of: e-mail, voicemail, fax, wireless transmission, and other electronic communication.

7. The geographical indexing system of claim 1, wherein the processor further:
(iii) determines at least one targeted search result contact from the indexed search results in (ii);
(iv) receives a user request for information;
(v) sends the user request for information to the at least one targeted search result contact;
(vi) receives at least one response from the at least one targeted search result contact.

8. The geographical indexing system of claim 7, wherein the processor further performs an action selected from the group consisting of: displaying the at least one response from (vi), storing the at least one response from (vi), forwarding the at least one response from (vi).

9. The geographical indexing system of claim 7, wherein the at least one targeted search result contact is determined by first displaying the search results followed by an action selected from the group consisting of: selecting at least one of the displayed search results, selecting all of the displayed search results, selecting the displayed search results within a geographical zone.

10. The geographical indexing system of claim 7, further comprising a database wherein all received responses are saved in the database and aggregated and then followed by an action selected from the group consisting of: being displayed to the user and being sent to the user using a method selected from the group consisting of: e-mail, voicemail, fax, mail, wireless transmission, and other electronic communication.

11. A method for geographically indexing a plurality of search results, said method comprising:
(a) obtaining a user-selected location by:
(i) providing a user with a graphical geographical map;
(ii) receiving the user-selected location as selected by the user on the graphical geographical map; and
(b) indexing the plurality of search results based on the user-selected location.

12. The method of claim 11, further comprising an action selected from the group consisting of: displaying the indexed search results from (b), storing the indexed search results from (b), forwarding the indexed search results from (b).

13. The method of claim 11, wherein the user-selected location is selected from the group consisting of: the user's work location, the user's home location, an alternative user location, a user GPS position, a street intersection, street address, landmark, a neighbourhood, a user-defined geographical zone.

14. The method of claim 11, further comprising displaying one or more of previous user-selected locations on the graphical geographical map.

15. The method of claim 11, wherein one or more of the indexed search results are displayed on the graphical geographical map.

16. The method of claim 11, further comprising sending one or more of the indexed search results to a mobile device using a method selected from the group consisting of: e-mail, voicemail, fax, mail, wireless transmission, and other electronic communication.

17. The method of claim 11, further comprising:
(c) determining at least one targeted search result contact from the indexed search results in (b);
(d) receiving a user request for information;
(e) sending the user request for information to the at least one targeted search result contact;
(f) receiving at least one response from the at least one targeted search result contact.

18. The method of claim 17, further comprising an action selected from the group consisting of: displaying the at least one response from (f), storing the at least one response from (f), forwarding the at least one response from (f).

19. The method of claim 17, wherein the at least one targeted search result contact is determined by first displaying the search results followed by an action selected from the group consisting of: selecting at least one of the displayed search results, selecting all of the displayed search results, selecting the displayed search results within a geographical zone.

20. The method of claim 17, further comprising saving all received responses in a database and aggregating them followed by an action selected from the group consisting of: being displayed to the user and being sent to the user using a method selected from the group consisting of: e-mail, voicemail, fax, mail, wireless transmission, and other electronic communication.

21. A request for information system for use in association with a plurality of search results, said indexing system comprising:
(a) a memory for storing a user request for information;
(b) a processor coupled to the memory for:
(i) determining at least one targeted search result contact from the plurality of search results;
(ii) receiving the user request for information;
(iii) sending the user request for information to the at least one targeted search result contact; and
(iv) receiving at least one response from the at least one targeted search result contact.

22. The request for information system of claim 21, wherein the processor further performs an action selected from the group consisting of: displaying the at least one response from (iv), storing the at least one response from (iv), forwarding the at least one response from (iv).

23. The request for information system of claim 22, wherein the at least one targeted search result contact is determined by first displaying the search results followed by a method selected from the group consisting of: selecting at least one of the displayed search results, selecting all of the displayed search results, selecting the displayed search results within a geographical zone, selecting the displayed search results within a user-specified distance from a user-selected location.

24. The request for information system of claim 21, wherein a user request for information is sent to the at least one search result contact using a method selected from the group consisting of: e-mail, voicemail, fax, mail, wireless transmission, and other electronic communication.

25. The request for information system of claim 21, further comprising a database wherein all received responses are saved in the database and where one of: the received responses are aggregated and the received responses are sent individually to the user.

26. The request for information system of claim 25, wherein the aggregated responses are then displayed to the user and sent to the user using a method selected from the group consisting of: e-mail, voicemail, fax, mail, wireless transmission, and other electronic communication.

27. The request for information system of claim 26, wherein the aggregated responses are sent to the user at predefined time intervals as defined by one of the user and the request for information system.

28. The request for information system of claim 21, wherein the processor further:
(v) obtains the user-selected location by:
(I) providing a user with a graphical geographical map;
(II) receiving the user-selected location as selected by the user on the graphical geographical map; and
(vi) indexes the plurality of search results based on the user-selected location.

29. The request for information system of claim 28, the processor further performs an action selected from the group consisting of: displaying the indexed search results from (vi), storing the indexed search results from (vi), forwarding the indexed search results from (vi).

30. The request for information system of claim 28, wherein the user-selected location is selected from the group consisting of: the user's work location, the user's home location, an alternative user location, a user GPS position, a street intersection, street address, landmark, a neighbourhood, a user-defined geographical zone.

31. A method for use in association with a plurality of search results, said method comprising:
(a) determining at least one targeted search result contact from the plurality of search results;
(b) receiving the user request for information;
(c) sending the user request for information to the at least one targeted search result contact; and
(d) receiving at least one response from the at least one targeted search result contact.

32. The method of claim 31, further comprising an action selected from the group consisting of: displaying the at least one response from (d), storing the at least one response from (d), forwarding the at least one response from (d).

33. The method of claim 32, wherein the at least one targeted search result contact is determined by first displaying the search results followed by a method selected from the group consisting of: selecting at least one of the displayed search results, selecting all of the displayed search results, selecting the displayed search results within a geographical zone.

34. The method of claim 31, wherein a user request for information is sent to the at least one search result contact using a method selected from the group consisting of: e-mail, voicemail, fax, mail, wireless transmission, and other electronic communication.

35. The method of claim 31, further comprising saving all received responses in a database and aggregated.

36. The method of claim 35, wherein the aggregated responses are then one of: displayed to the user and sent to the user using a method selected from the group consisting of: e-mail, voicemail, fax, mail, wireless transmission, and other electronic communication.

37. The method of claim 36, wherein the aggregated responses are sent to the user at predefined time intervals as defined by one of the user and the request for information system.

38. The method of claim 31, further comprising:
(e) obtaining the user-selected location by:
(i) providing a user with a graphical geographical map;
(ii) receiving the user-selected location as selected by the user on the graphical geographical map; and
(f) indexing the plurality of search results based on the user-selected location.

39. The method of claim 38, further comprising an action selected from the group consisting of: displaying the indexed search results from (f), storing the indexed search results from (f), forwarding the indexed search results from (f).

40. The method of claim 38, wherein the user-selected location is selected from the group consisting of: the user's work location, the user's home location, an alternative user location, a user GPS position, a street intersection, street address, landmark, a neighbourhood, a user-defined geographical zone.
